(19) United States
(12) Patent Application Publication
(10) Pub. No.: US 2024/0367230 A1
(43) Pub. Date: Nov. 7, 2024

(54) METHOD OF MAKING MAX PHASE STRUCTURES

(71) Applicant: UCHICAGO ARGONNE, LLC, Chicago, IL (US)

(72) Inventors: Dileep Singh, Naperville, IL (US); Beihai Ma, Naperville, IL (US)

(21) Appl. No.: 18/141,815

(22) Filed: May 1, 2023

(51) Int. Cl. B22F 3/26; B22F 3/15; B22F 5/10

(52) U.S. Cl. CPC B22F 3/26; B22F 3/15; B22F 5/10; B22F 2302/10; B22F 2302/20; B22F 2302/40

(57) ABSTRACT

A method of forming MAX phase structures having one or more apertures includes filing a green body having one or more apertures with an insert powder and sintering while applying a load to the insert filled green body to from the MAX phase structure.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates to methods of making MAX phase structures and, in particular, methods of making MAX phase structures having one or more apertures.

### BACKGROUND

Mₙ₊₁AXₙ is the general formula for a large group of materials with the same crystalline structure, where “M” corresponds to an early transition metal element, “A” is an A-group element, “X” is carbon or nitrogen, and n=1, 2, or 3. Such materials are conventionally referred to as MAX phase materials. MAX phases are layered hexagonal compounds, belonging to space group P63/mmc, with two formula units per unit cell. They can be classified according to their values of n: 211 for M₂AX (n=1), 312 for M₃AX₂ (n=2), and 413 for M₄AX₃ (n=3). So far, MAX phases with more than 100 different compositions have been discovered. The M-X bonds are exceptionally strong because of their mixed metallic-covalent nature, while the M-A bonds are relatively weak. This unique crystal structure is responsible for the characteristic layered structure and the unique combination of properties that enable the MAX phase materials to play a role in bridging the gap between ceramics and metals. Desirable properties of MAX phase materials include high electrical conductivity and thermal conductivity, light weight, machinability, superior mechanical properties, thermal-shock resistance, corrosion resistance, radiation-damage tolerance, and self-healing. MAX phase materials exhibit advantageous performance characteristics at elevated temperatures when compared to high-temperature superalloys. They have been explored for use as structural materials for high-temperature applications including concentrating solar-thermal power (CSP) systems, solar-thermal energy storage, and solar energy for industrial processes.

### SUMMARY

There is a need in the art for a method of making MAX phase structures having shapes other than disk shape and in particular, methods of making MAX phase structures with apertures, such as a tube shape. Current methods of making MAX phase structures can result in cracking when apertures are present in the structure.

A method of making a MAX phase structure comprising one or more apertures in accordance with the disclosure can include forming precursor powder into a green body structure having one or more apertures; filling the one or more apertures with an insert powder such that the insert powder completely fills the one or more apertures; sintering the insert powder filled green body while applying a pressure load from a pressure applying insert applied to the insert powder filled green body to thereby form the MAX phase structure.

For example, the green body having one or more apertures can be formed by compressing the precursor powder into a die having a desired shape with one or more die inserts for forming one or more apertures in the green body to thereby define the green body having one more apertures. The die inserts can then be removed before filing with the insert powder.

Alternatively, the green body can be formed by other methods, such as additive manufacturing, 3D printing, or a computer-controlled process that creates three dimensional objects by depositing materials layer-by-layer manufacturing methods. The green body having the one or more apertures can then be contained in retaining structure for filing with the insert powder and sintering under the applied load.

The MAX phase structure resulting from the methods of the disclosure comprises a MAX phase compound of formula Mₙ₊₁AXₙ, wherein n is 1-4. The precursor powder comprises a powder of M, a powder of A, and one or both of a powder of a carbide of M and a powder of a nitride of M. The insert powder comprises a material that does not sinter at a temperature at which the green body is sintered.

### BRIEF DESCRIPTION OF THE DRAWINGS

FIG. 1A is a photograph of a graphite tooling assembly for use in a method of the disclosure loaded into a DCS 10 chamber.

FIG. 1B is a photograph of the tooling assembly at sintering temperature.

FIG. 1C is a photograph of a MAX phase disk sample.

FIG. 2 is an XRD pattern of MAX phase Ti₃SiC₂ sample field assisted sintering, sintered in vacuum at 1375° C. for 15 min under 40 MPa loading pressure.

FIGS. 3A and 3B are surface SEM images of MAX phase Ti₃SiC₂ structures.

FIG. 4 is a graph showing Vickers hardness of MAX phase Ti₃SiC₂ sample measured with 9.8 N load for 15 sec.

FIG. 5 is a room temperature IV curve of MAX phase Ti₃SiC₂ sample.

FIG. 6A is a graph showing temperature-dependent heat capacity of a MAX phase Ti₃SiC₂ sample.

FIG. 6B is a graph showing temperature-dependent thermal diffusivity and thermal conductivity of MAX phase Ti₃SiC₂ sample.

FIG. 7A is a schematic illustration of loading precursor powder into a tooling for forming the green body.

FIG. 7B is a schematic illustration of sintering using a tooling having the die insert retained and without filling with the insert powder.

FIG. 8 is a graph showing the calculated residual stress in a Ti₃SiC₂ tube as a function of temperature decrease from the processing temperature of 1375° C.

FIGS. 9A and 9B are schematic illustrations of a method of the disclosure showing (A) compressing the precursor powder to form the green body with a die insert being used for forming the aperture; and (B) removal of the die insert and filling the aperture with the insert powder and application of a pressure load during sintering.

FIG. 10 is a photograph of MAX phase Ti₃SiC₂ short tubes or rings (42 mm OD, 36 mm ID, and 20 mm L) fabricated by a method in accordance with the disclosure.

FIG. 11 is an x-ray diffraction pattern of 1400° C./6-h annealed MAX phase tube that was sintered at 1350° C. under 30 MPa pressure for 30 min in vacuum with the insert powder being used.

FIGS. 12A and 12B are photographs of a MAX phase (Ti₃SiC₂) tube sample (A) before and (B) after 1400° C./6-h annealing prepared in accordance with the disclosure.

FIGS. 13A and 13B are photographs of a MAX phase Ti₃SiC₂ tube after 1400° C. annealing for 6 h in accordance with the disclosure and surface grinding until clean: (A) side view and (B) top view

### DETAILED DESCRIPTION

In accordance with the disclosure, a method of making a MAX phase structure comprising one or more apertures can include forming a precursor powder into a green body having one or more apertures; filling the apertures with an insert powder such that the insert powder completely fills the apertures; placing a pressure applying insert on a surface of the insert powder filled green body; and sintering the insert powder filled green body while applying a pressure load to the insert powder to thereby from the MAX phase structure.

For example, the green body having one or more apertures can be formed by compressing the precursor powder into a die having a desired shape with one or more die inserts for forming one or more apertures in the green body to thereby define the green body having one more apertures. The die inserts can then be removed before filing with the insert powder.

Alternatively, the green body can be formed by other methods, such as additive manufacturing, 3D printing, or a computer-controlled process that creates three dimensional objects by depositing materials layer-by-layer manufacturing methods. The green body having the one or more apertures can then be contained in retaining structure for filing with the insert powder and sintering under the applied load. Any know green body forming methods can be used and sintering under load can be done with the assistance of a retaining structure to hold the green body when produced without use of a die-preform. Examples of green body forming methods, include, bur are not limited to extrusion, slip casting, tape casting, injection molding, cold isostatic pressing, additive manufacturing, and three-dimensional printing technology.

The MAX phase structures prepared by the methods in accordance with the disclosure have at least one aperture. The MAX phase structures include or are formed of a MAX phase compound of formula Mₙ₊₁AXₙ, wherein n is 1-4. M is an early transition metal, A is an A-group element, and X is carbon or nitrogen.

M can be one or more of one or more of tantalum (Ta), hafnium (Hi), titanium (Ti), vanadium (V), chromium (Cr), niobium (Nb), molybdenum (Mo), and zirconium (Zr).

A can be one or more of aluminum (AI), tin (Sn), silicon (Si), phosphorous (P), sulfur(S), gallium (Ga), germanium (Ge), arsenic (As), cadmium (Cd), indium (In), thallium (TI), and lead (Pb).

X is a carbide and or nitride of M. For example, the precursor powder can include only a carbide of M, only a nitride of M, or both a carbide and a nitride of M.

In the methods of the disclosure, the precursor powder includes a powder of M, a powder of A, and one or both of a powder of a carbide of M and a powder of a nitride of M.

For example, a MAX phase compound having the formula Ti₃SiC₂ can be prepared using titanium powder, silicon powder, and TiC powder. For example, the precursor powder to prepare such a MAX phase compound can include a ratio of Ti:Si:TiC of about 1:1:2.

In the precursor powder, the powder of M can be present in an amount of about 20 wt % to about 75 wt %, about 30 wt % to about 60 wt %, about 25 wt % to about 50 wt %, about 45 wt % to about 70 wt %, each based on the total weigh to the precursor powder. Other suitable amounts include, based on the total weight of the precursor powder, about 20, 25, 30, 35, 40, 45, 50, 55, 60, 65, 70, 75 wt % and any values therebetween and any ranges defined by these values.

In the precursor powder, the powder of A can be present in an amount of about 10 wt % to about 20 wt %, about 15 wt % to about 20 wt %, about 12 wt % to about 16 wt %, each based on the total weight of the precursor powder. Other suitable amounts, based on the total weight of the precursor powder include about 10, 12, 14, 16, 18, 20 wt %, and any values therebetween and any ranges defined by these values.

In the precursor powder, the carbide and/or nitride of M can be present in a total amount of about 1 wt % to about 70 wt %, about 30 wt % to about 60 wt %, about 25 wt % to about 50 wt %, about 45 wt % to about 70 wt %, 10 wt % to about 20 wt %, about 15 wt % to about 45 wt %, or about 25 wt % to about 55 wt %, %, each based on the total weight of the precursor powder. Other suitable amounts, based on the total weight of the precursor powder include about 1, 5, 10, 15, 20, 25, 30, 35, 40, 45, 50, 55, 60, 65, 70 wt %, and any values therebetween and any ranges defined by these values.

The precursor powder can be prepared by admixing the powder of M, the powder of A, and one or both of the powder of a carbide of M and the powder of a nitride of M with an organic solvent to form a slurry and then drying the slurry to form the precursor powder. Any suitable organic solvent can be used and can be readily selected by the skilled person based on the component powders to be mixed. The components of the precursor powder can be admixed by any suitable mixing methods. For example, the precursor powder can be admixed by ball mixing. Drying of the precursor slurry to form the precursor powder can be done using well known conditions and processes in the art for drying slurries.

The green body can be formed into the desired shape with one or more apertures, for example, by compressing the precursor powder into a die having one or more die inserts. Any suitable die and die inserts can be used with any desired shape and any desired number of apertures. The die can be used to form the desired perimeter shape of the green body and one or more die inserts are inserted into the die to define the one or more apertures extending through the green body. For example, the green body can be formed into the shape of a tube with a cylindrical die and a central cylindrical die insert for defining the central tube aperture. Sintering is performed after removal of the die insert, but the green body can be maintained in the die to facilitate retaining the perimeter shape, as well as providing a structure against which the pressure applying insert can be press to apply the desired load to the insert filled green body.

Any known green body forming method can be used for forming the green body. For green body formation methods in which a die or preform is not used or for which the die or preform is not suitable for sintering, the as-formed green body can be held in a retaining structure for sintering under the applied load. For example, graphite retaining structures can be used.

The insert powder comprises a material that does not sinter at a temperature at which the green body is sintered. For example, the insert powder can be one or more of graphite, silica, boron nitride, and sand. The insert powder can have any suitable particle size. For example, the average particle size of the insert powder can be about 1 μm to about 50 μm.

Filling the one or more apertures with the insert powder can include filling the apertures as well as applying a layer of insert powder on a surface of the green body, such that a layer of insert powder is disposed between the surface of the green body and the pressure applying insert. For example, in a tube-shaped green body, the central aperture can be filled with the insert powder and additional insert powder can added to cover the top surface of the green body such that insert powder is disposed between the top surface of the green body and the pressure applying insert, which applies the load to the top surface.

The pressure applying insert applies a load to the green body, but as a result of the filling with the insert powder does not enter into the aperture of the green body. The load can be applied from any desired angle. For example, a top insert can be used to apply a load to the top of the green body during sintering.

The pressure applying insert can apply a load of about 5 MPa to about 100 MPa, about 10 MPa to about 20 MPa, or about 30 MPa to about 40 MPa. Other suitable loads include about 5, 10, 15, 20, 30, 35, 40, up to 100 MPa and any values therebetween and any ranges defined by the values.

The load is maintained during sintering. Sintering can be performed, for example, at a temperature of about 1300° C. to about 1500° C. A suitable sintering temperature can be readily selected depending on the components of the precursor powder and the metal and A-group element compounds to be formed into the MAX phase. The sintering can be performed using field assisted sintering. For example, field assisted sintering can be performed with an applied voltage of about 5V to 30V and a current up to 150 kA. Other sintering methods, such as hot isostatic pressure sintering are also contemplated herein.

Sintering can optionally be performed under an inert gas (N₂, Ar, He) flowing atmosphere or under vacuum. For example, the vacuum can be maintained by continuous pumping.

The method of the disclosure can further include a second sintering step, after the first sintering and removal of the resulting MAX phase structure from the die. The resulting MAX phase structure can be further sintered in a furnace, for example, a tube furnace. The sintering can be performed at a temperature of about 1300° C. to about 1500° C. It has been observed that the second sintering can improve densification of the MAX phase.

### EXAMPLES

### Precursor Preparation:

In the examples disclosed herein, a precursor powder prepared as followed was used. Precursor powder mixture was prepared using titanium powder (Alfa Aesar,-325 mesh, 99.5% purity), silicon powder (Alfa Aesar, particle size 1-5 μm, 99.9% purity), and TiC powder (Inframate Advanced Materials, average particle size 3 μm, 99.7% purity) as starting chemicals with molar ratio Ti:Si:TiC=1:1:2. Batching of the powder mixture was performed inside a nitrogen-filled glovebox. The powder blend was mixed at room temperature in a Nalgene bottle filled with alumina grinding balls and ethyl alcohol (Thermo Fisher Scientific, denatured, >99% purity) with a total powder-to-grinding-ball weight ratio of 1:3 to 3:1 and a total powder-to-solution weight ratio of 3:2 to 1:5. Methods of the disclosure contemplate using any known grinding containers and processes. The slurry was ball-milled overnight and then vacuum-dried at room temperature. The dried powder mixture was subsequently ball-milled for 4 hours and then the alumina grinding balls were separated from the resulting dry powder mixture using a sieve.

### Sample Characterization:

Phase components were determined by XRD with crushed powders made from sintered samples using a Bruker D2 Phaser XRD system. The microstructure and elemental composition were studied by SEM using a Hitachi S-4700-II field emission SEM system. Vickers hardness (HV) measurement was carried out with a Tinius Olsen indentation hardness tester using 9.8 N of force for a dwell time of 15 sec as per ASTM Standard C1327 [18]. Four-point bending flexure strength tests were performed at room temperature on rectangular-bar-shaped specimens measuring 3 mm×4 mm×20 mm, cut from the MAX phase Ti₃SiC₂ composite disks according to ASTM Standard C1161-18 [19].

Electrical conductivity was measured on rectangular bar specimens by the 4-probe method using a Keithley 6221/2182A Delta Mode Low Noise Precision AC/DC Current Source and Nanovoltmeter system. Electrical contacts were made via pressure contact using a Signatone probe station with gold-plated tungsten probes. The resistance of a specimen is determined from the slope of the IV curve being measured. Conductivity is determined in accordance with ASTM Standard B193 [20], with consideration of specimen geometry. Thermal diffusivity and thermal conductivity were measured by light flashing analysis (LFA) with specimens 10 mm×10 mm×≈2.5 mm in size, using a Netzsch LFA 467 HyperFlash tester in accordance with ASTM Standard E1461-13 [21]. Specimens for testing were polished to a 600 grit finish and spray coated with ≈5-μm-thick graphite coating before testing. Ultrahigh-purity (UHP, 99.999% pure) helium gas was flowed through the system during testing. Standard reference specimens of pyroceramic 9606 and graphite POCO were tested concurrently with MAX phase Ti₃SiC₂ specimens.

### Example 1: Disk Shaped Samples

To confirm that field assisted sintering technology was capable of producing MAX phase materials, disk shaped samples were prepared using a 30 mm-diameter graphite die inside a DCS 10 furnace (Thermal Technology, Santa Rosa, CA). The DCS 10 utilized pulsed DC operating at a low voltage of less than 10 V and high current of up to 5,000 A. The DCS 10 furnace rapidly heats a sample inside a conductive tooling assembly under simultaneous uniaxial pressure in vacuum or a controlled inert gas flowing atmosphere. It was observed that the field assisted sintering technology process of the disclosure resulted in highly dense bulk materials with ultra-fine grain structures.

Before the precursor powder was loaded, 125-μm thick graphite foil was cut to appropriate sizes and used as a liner for the protection of the graphite tooling. About 13 g of precursor powder was used for making MAX phase Ti₃SiC₂ composite disks having a 30 mm diameter and an about 4 mm thickness. Reactive sintering was conducted in vacuum at a sample temperature between 1350° C. and 1400° C. for a dwell time of 10 to 30 min. under a loading pressure of about 10 to 40 MPa. A typical heating/cooling rate of about 50° C./min and a loading pressure engagement rate of about 2 to 10 MPa/min were used.

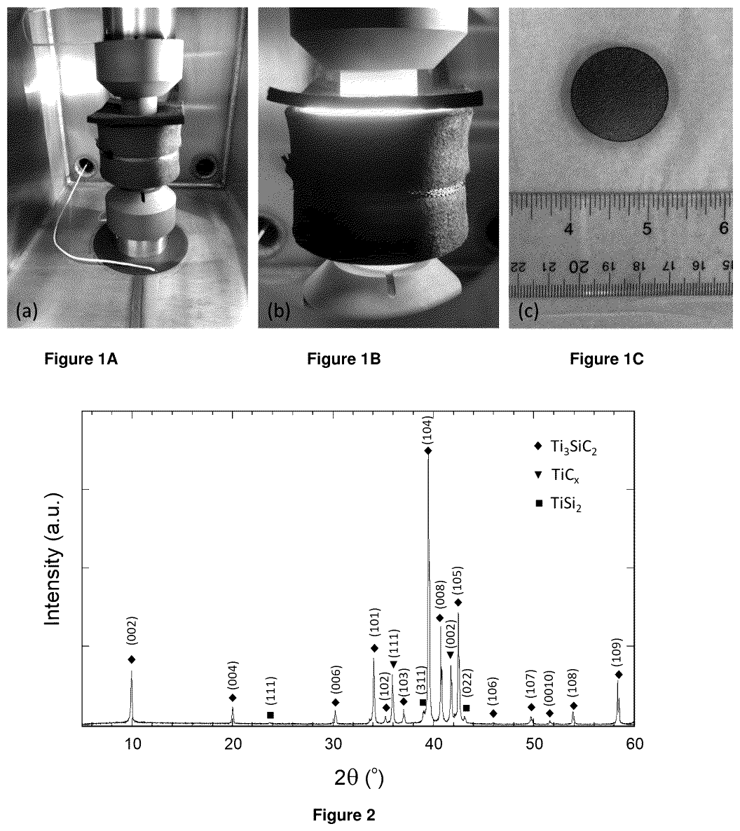

FIG. 1A is a photograph of the graphite tooling assembly used as loaded in the DCS 10 furnace chamber. The tooling assembly included top and bottom ram spacers, top and bottom sample punches, and a 30-mm-dia die, all made of high-quality SK-50 graphite. FIG. 1B shows the tooling assembly at sintering temperature. FIG. 1C shows the resulting MAX phase disk.

The precursor powder mixture containing titanium, silicon, and titanium carbide in a 1:1:2 ratio (Ti+Si+2TiC) was placed inside the graphite die between the top and the bottom punches. The graphite die was wrapped in double layers of 0.25-in.-thick graphite felt to minimize radiation heat loss during the sintering process (FIG. 1B). An as-sintered MAX phase disk sample 30 mm in diameter and ≈4 mm thick is shown in FIG. 1C. After removal of graphite foil residuals affixed to the surfaces of the resulting MAX phase composite samples, the samples were cut into rectangular bars ≈4 mm wide, ≈3 mm thick, and ≈20 mm long using a precision low-speed saw with a diamond cutting blade. These rectangular bar specimens were mechanically polished to a 400 grit finish before use for mechanical property testing. End cutoff pieces were used for making crushed powder samples for XRD analysis and for fracture surface SEM observations.

FIG. 2 shows a crushed-powder XRD pattern of a MAX phase Ti₃SiC₂ 30-mm-dia composite disk specimen produced by FAST sintering at 1375° C. for 15 min in vacuum with 40 MPa loading pressure applied. All diffraction peaks can be indexed. This sample consists of mostly Ti₃SiC₂ phase (JCPDS card 00-065-3559) and TiCₓ phase (JCPDS card 00-065-3842), with traceable tiny peaks (at 2θ=23.7°, 39.0°, and) 43.1° that are associated with the TiSi₂ phase. Table 1 lists phase compositions, as determined by XRD analysis, of several MAX phase Ti₃SiC₂ samples that were fabricated with the same processing conditions (FAST sintering in vacuum at 1375° C. for 15 min with 40 MPa loading pressure). Ti₃SiC₂ phase fractions range from 83% to 93% in these disk samples.

TABLE 1
Phase compositions of MAX phase samples determined
from X-ray diffraction analysis.

| | | | | Calc. Based on | | Calc. Based on | |
|---|---|---|---|---|---|---|---|
| | Peak Intensity (%) | | | TiCₓ (200) Intensity | | TiCₓ (111) Intensity | |
| | Ti₃SiC₂ | TiCₓ | TiCₓ | Ti₃SiC₂ | TiCₓ | Ti₃SiC₂ | TiCₓ |
| Sample ID | (104) | (200) | (111) | content | content | content | content |
| BM211025 | 100 | 31.10 | 26.40 | 91.59 | 8.41 | 89.21 | 10.79 |
| BM211026 | 100 | 37.10 | 26.10 | 88.45 | 11.55 | 89.44 | 10.56 |
| BM211027 | 100 | 35.20 | 38.80 | 89.44 | 10.56 | 79.76 | 20.24 |
| BM211028 | 100 | 28.40 | 26.60 | 93.00 | 7.00 | 89.06 | 10.94 |
| BM211210 | 100 | 43.40 | 36.80 | 85.15 | 14.85 | 81.28 | 18.72 |
| BM211213 | 100 | 47.00 | 37.00 | 83.27 | 16.73 | 81.13 | 18.87 |
| BM220113 | 100 | 35.90 | 28.60 | 89.45 | 10.55 | 87.92 | 12.08 |
| BM220117 | 100 | 33.20 | 27.50 | 90.33 | 9.67 | 88.36 | 11.64 |

The bulk density of the MAX phase Ti₃SiC₂ composite samples ranged from 4.54 to 4.57 g·cm⁻³, with an average value of 4.56 g·cm⁻³, as determined by the Archimedes principle using isopropyl alcohol (density of 0.786 g·cm⁻³ at 20° C.) as the immersing fluid. The theoretical density of the composite sample was estimated using the simple mixing rule. For example, in the case of a sample consisting of 90% MAX phase Ti₃SiC₂ (density of 4.52 g·cm⁻³) and 10% TiC phase (density of 4.93 g·cm⁻³), its theoretical density as determined by the simple mixing rule is 4.56 g·cm⁻³. Therefore, the samples exhibited a bulk density of =100% of the theoretical value.

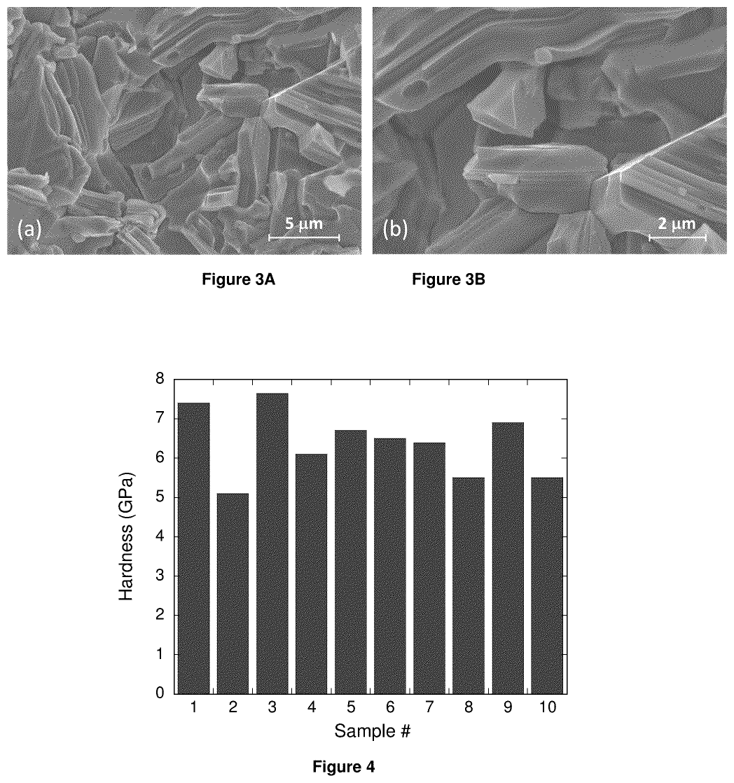

FIG. 3 shows fracture surface SEM images of a MAX phase Ti₃SiC₂ composite sample at two different magnifications. A layered grain structure with typical grain size of 2 to 5 μm thick and 5 to 10 μm long was clearly visible from the fracture surface. Many plate-shaped MAX phase Ti₃SiC₂ grains were interconnected, with high angles between their respective plate-shaped grain orientations, as shown in FIG. 3. Such grain structure effectively retards any crack propagation and promotes the fracture strength of MAX phase materials.

FIG. 4 shows HV measured on a MAX phase Ti₃SiC₂ sample made by the FAST process in vacuum at 1375° C. for 15 min under 40 MPa loading pressure. Specimens for HV testing were polished mechanically and finished with 1-μm diamond paste polishing. Indentation hardness tests were conducted following ASTM Standard C1327 on the polished surface at 10 different locations. Each Vickers indent was made using a 9.8-N loading force and a 15-sec dwell time. The measured HV values ranged from 5.1 to 7.6 GPa for the MAX phase Ti₃SiC₂ samples made by the FAST process, as plotted in FIG. 4. The data result in an average hardness value of 6.4±0.8 GPa.

The flexure strengths of MAX phase Ti₃SiC₂ samples were measured with rectangular bar specimens at room temperature in accordance with ASTM Standard C1161-18. A total of twelve specimens were tested and an average flexure strength of 519±32 MPa was found. Fitting strength data to a 2-parameter Weibull distribution, characteristic strength σ_{θ}=537 MPa and Weibull modulus m=36.3 was obtained.

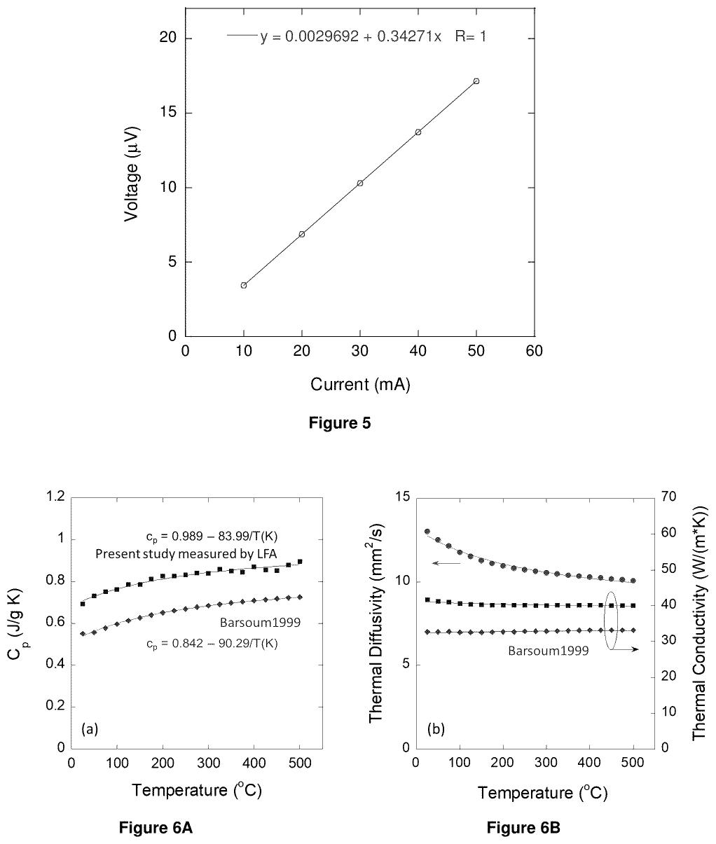

FIG. 5 shows a current-voltage (IV) curve of a MAX phase Ti₃SiC₂ sample measured at room temperature with applied current up to 50 mA. The rectangular bar specimen was cut from a 30-mm-dia disk fabricated by the FAST process in vacuum at 1375° C. for 15 min under 40 MPa loading pressure and mechanically polished to height H=2.93 mm and width W=3.99 mm. The separation of the voltage probes d_{W} was 15.2 mm. Low current was used to avoid potential ohmic heating of the specimen. From the slope of the IV curve, an electrical resistance R=0.3427 mΩ for this specimen was obtained. Thus, the resistivity p at the testing temperature of 24.6° C. can be calculated as follows: p=R·H·W/d_{W}=26.0 μΩ·cm. Using the temperature coefficient of resistivity for MAX phase Ti₃SiC₂ that was reported as 0.004 K⁻¹, a measured electrical resistivity of 25.6μΩ·cm at 20° C., or conductivity σ=1/ρ=3.9 MS·m⁻¹ at 20° C. was obtained. It was observed that that the electrical conductivity of the samples was ≈15% lower than the value of 4.5 MS·m⁻¹ reported by Barsoum and El-Raghy.

FIG. 6 shows the temperature-dependent heat capacity, thermal diffusivity, and thermal conductivity of a MAX phase Ti₃SiC₂ composite sample fabricated by the FAST process in vacuum at 1375° C. for 15 min under 40 MPa loading pressure. As shown in FIG. 6A, the heat capacity of the MAX phase Ti₃SiC₂ composite sample that was measured by the LFA technique displayed a similar trend, but with values ≈20% higher, when compared to that reported by Barsoum et al. (plotted in FIG. 6a with green diamonds). The temperature-dependent thermal conductivity, K, was calculated using equation (1):

$$κ = α \cdot ρ \cdot {c}_{p} , \qquad ( 1 )$$

where α is the thermal diffusivity, ρ the density, and cₚ the heat capacity. Temperature-dependent thermal diffusivity is plotted in FIG. 6b (red dots associated with left y-axis). Temperature-dependent thermal conductivity calculated using thermal diffusivity data that was measured by LFA is plotted in FIG. 6b with blue squares, while thermal conductivity calculated using cₚ data reported by Barsoum et al. is plotted in FIG. 6B with green diamond symbols (both associated with the right y-axis). It was observed that the thermal conductivity of MAX phase Ti₃SiC₂ composite samples fabricated by FAST decreases slightly from a value of 43 W·m⁻¹·K⁻¹ at room temperature to a value of 40 W·m⁻¹·K⁻¹ at 500° C.

### Example 2: Tubular Shaped MAX Phase Structures

Tubular MAX phase Ti₃SiC₂ structures were generated using a graphite tooling that was designed to enable suitable electrical current paths through the material. The graphite tooling was made using micro-grain high-strength graphite SK-50. It was observed that the methods of the disclosure greatly reduced crack formation.

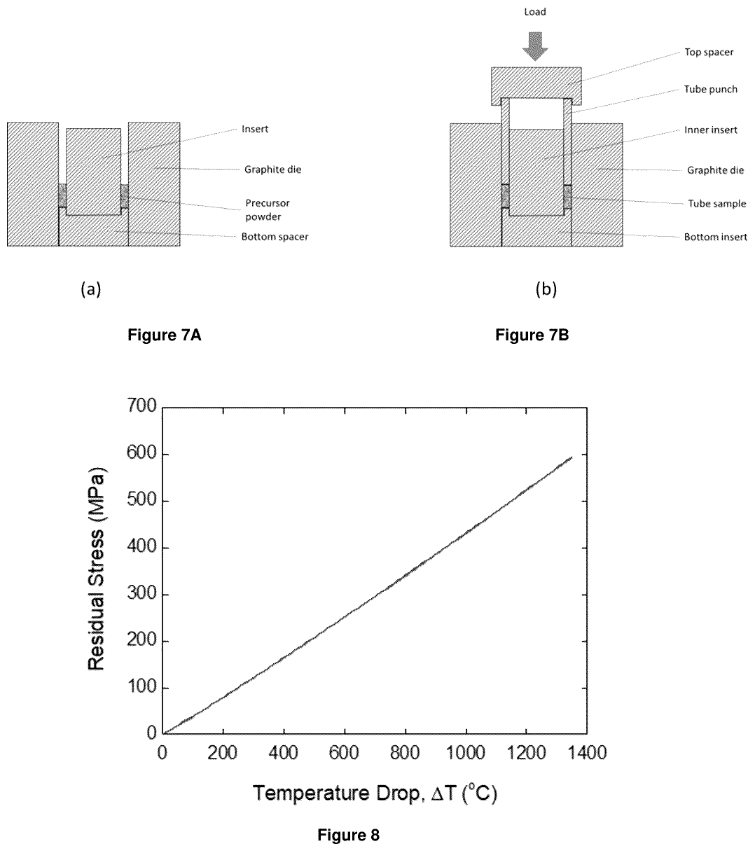

FIGS. 7A and 7B illustrate graphite tooling used in comparative examples for making tubular MAX phase Ti₃SiC₂ structures. Cracks developed in these samples. Stress analysis of the samples produced using this tooling indicated that cracks were the result of mismatch in the coefficient of thermal expansion between graphite (≈6×10⁻⁶° C.⁻¹) and the MAX phase Ti₃SiC₂ (9.3×10⁻⁶° C.⁻¹). MAX phase Ti₃SiC₂ exhibits a higher CTE than the graphite inner insert rod inside it. After high-temperature sintering at 1375° C., the MAX phase Ti₃SiC₂ tube shrinks more than the graphite rod during cooling. As shown in FIG. 8, a residual stress of ≈600 MPa can be expected when the MAX phase tube cools down from 1375° C. to room temperature. This residual stress level is greater than the value of flexure strength that was measured with rectangular bar specimens at room temperature by the four-point bending method. Without intending to be bound by theory, it is believed that the coefficient of thermal expansion (CTE) mismatch causes the development of cracks in the tube, and eventually leads to crack failure. Therefore, the methods of the disclosure were developed to reduce the residual stress inside the MAX phase tube after high-temperature FAST sintering.

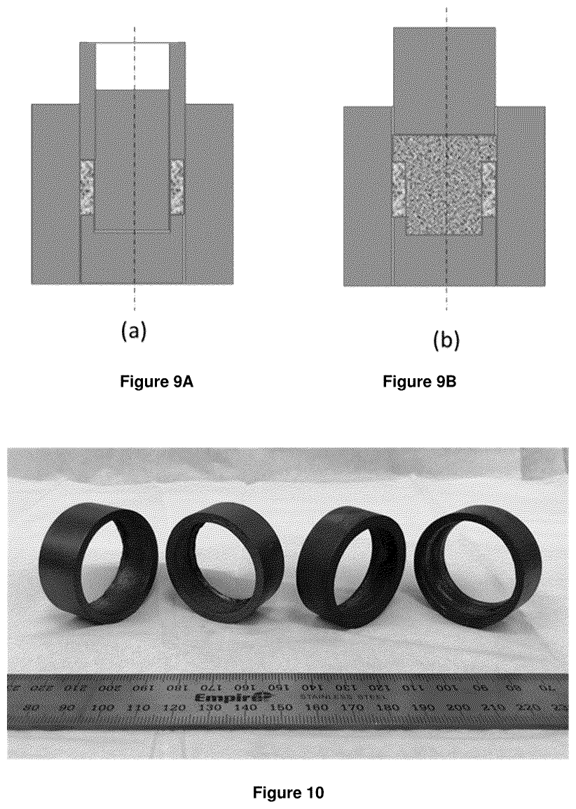

FIG. 9 illustrates a fabrication process in accordance with the disclosure which was used to make tubular samples to address the cracking problem observed. A green body tube by compressing loaded precursor powder using a ring punch, as shown in FIG. 9A. The inner insert was then removed, and the space was filled with a graphite powder. The top insert was put on top of the graphite powder for quasi-isostatic pressing during high-temperature FAST sintering in the DCS 10 furnace, as illustrated in FIG. 9B. Multiple MAX phase short tubes were successfully produced at 1350° C. to 1400° C. under 5 to 30 MPa for 10 to 30 min in vacuum using the DCS 10 furnace, as shown in FIG. 10.

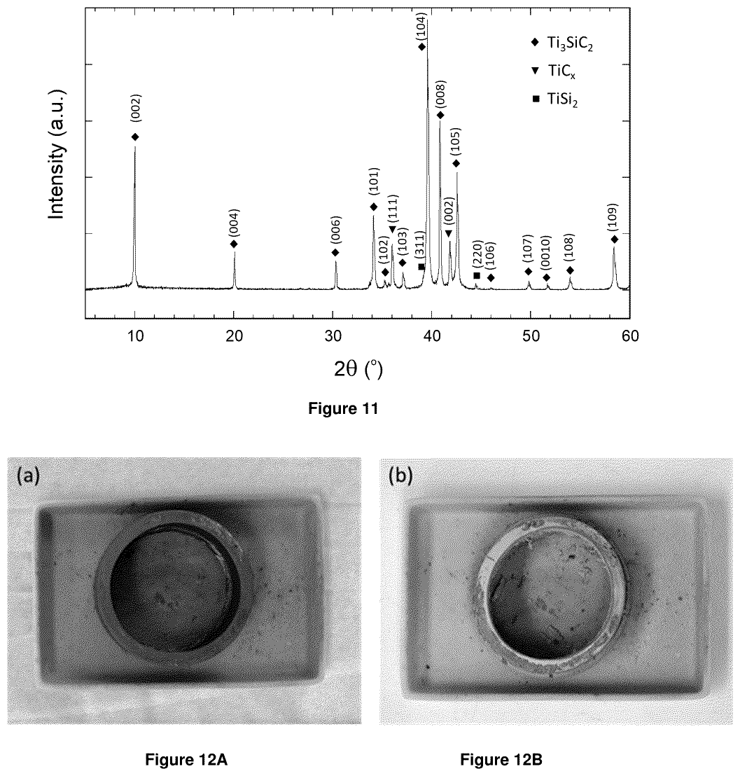

The as-prepared MAX phase tubes exhibited a bulk density of ˜70% and a low fraction of Ti₃SiC₂ phase, as determined by XRD. Traceable intermediate Ti₅Si₃ and TiSi₂ phases were detectable by XRD. To improve the bulk density and to enhance the MAX phase Ti₃SiC₂ fraction in these tubes, the tubers were annealed in a tube furnace at 1400° C. for 6 hours with a flowing argon atmosphere. After this annealing, the Ti₃SiC₂ phase in these FAST-produced tubes increased substantially to >95%, and the TiC content dropped to below 3%, as revealed by the XRD pattern shown in FIG. 11. Also, the bulk density of the tubes improved to up to 85% of its theoretical value after this annealing.

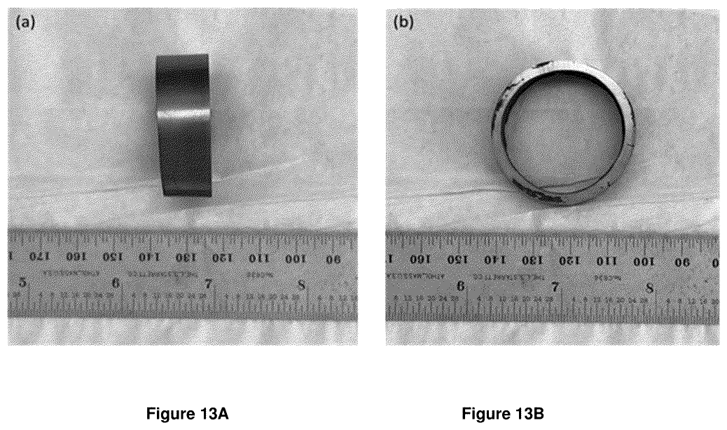

FIG. 12 shows photographs of a MAX phase tube prepared by FAST sintering before (FIG. 12a) and after (FIG. 12b) post-annealing heat treatment at 1400° C. for 6 h in an argon flowing atmosphere. FIG. 13 shows photographs of the MAX phase tube after 1400° C./6-h annealing and subsequent surface grinding. It is very similar in appearance to a black metal tube.

Table 2 lists sample dimensions, fracture strength, density, and porosity of MAX phase Ti₃SiC₂ tubes prepared by FAST sintering in graphite bedding. Density of the MAX phase tubes produced is approximately 3.8 g/cm³, corresponding to ≈85% of the theoretical value, or ≈15% porosity. The fracture strength of these MAX phase tubes was determined to be ≈250 MPa, which is in good agreement with the reported flexure strength value of 260±20 MPa measured at room temperature with rectangular bar specimens.

TABLE 2
Sample dimensions and properties of MAX phase tubes tested.

| Sample ID | BM220616 | BM220612 | BM220610T | Average |
|---|---|---|---|---|
| Length (mm) | 14.3 | 14.32 | 14.39 | 14.3 |
| Thickness (mm) | 2.41 | 2.7 | 2.43 | 2.5 |
| OD (mm) | 39.98 | 39.13 | 39.45 | 39.5 |
| ID (mm) | 35.16 | 33.72 | 34.59 | 34.5 |
| Fracture load (N) | 555.9 | 726.7 | 565 | 615.9 |
| Fracture strength | 251.7 | 254.5 | 246.3 | 250.8 |
| (MPa) | | | | |
| Density (g/cm³) | 3.84 | 3.77 | 3.79 | 3.80 |
| Porosity (%) | 15.0 | 16.6 | 16.3 | 15.97 |

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

[1] W. Jeitschko, H. Nowotny and F. Benesovsky, “Ti₂AlN, eine stickstoffhaltige H-Phase,” Monatshefte für Chemie, pp. 1198-200, 1963.
[2] W. Jeitschko, “Die kristallstruktur von Ti₃SiC₂-ein neuer komplexcarbid-typ,” Mh Chem, p. 171, 1965.
[3] M. Barsoum and T. El-Raghy, “Synthesis and characterization of a remarkable ceramic Ti₃SiC₂,” J Am Ceram Soc, vol. 79, no. 7, pp. 1953-1956, 1996.
[4] M. Barsoum, “The Mₙ₊₁AXₙ Phases: A New Class of Solids: Thermodynamically Stable Nanolaminates,” Prog Solid State Chem, vol. 28, no. 1-4, pp. 201-81, 2000.
[5] J. Gonzalez-Julian, “Processing of MAX phases: From synthesis to applications,” J Am Ceram Soc, vol. 104, no. 2, pp. 659-690, 2021.
[6] B. Radovic and M. Barsoum, “MAX phases: Bridging the gap between metals and ceramics,” Am Ceram Soc Bull, vol. 92, no. 3, pp. 20-27, 2013.
[7] Z. Sun, H. Hashimoto, W. Tian and Y. Zou, “Synthesis of the MAX phases by pulse discharge sintering,” Int J Appl Ceram Technol., vol. 7, no. 6, pp. 704-718, 2010.
[8] Z. Sun, “Progress in research and development on MAX phases: a family of layered ternary compounds,” Int Mater Rev, vol. 56, no. 3, pp. 143-166, 2011.
[9] M. Barsoum and M. Radovic, “Elastic and mechanical properties of the MAX phases,” Annu Rev Mater Res, vol. 41, no. 1, pp. 195-227, 2011.
[10] T. El-Raghy, M. Barsoum, A. Zavaliangos and S. Kalidindi, “Processing and mechanical properties of TigSiC2: II, Effect of grain size and deformation temperature,” J Am Ceram Soc, vol. 82, no. 10, pp. 2855-2860, 1999.
[11] T. El-Raghy, S. Wiederhorn, W. Luecke, M. Radovic and M. Barsoum, “Effect of temperature, strain rate and grain size on the mechanical response of Ti₃SiC₂ in tension,” Acta Mater, vol. 50, no. 6, pp. 1297-306, 2002.
[12] H. Zhang, Y. Zhou, Y. Bao and M. Li, “Abnormal thermal shock behavior of Ti₃SiC₂ and Ti₃AlC₂,” J Mater Res, vol. 21, no. 9, pp. 2401-2407, 2006.
[13] Y. Bao, X. Wang, H. Zhang and Y. Zhou, “Thermal shock behavior of Ti₃AlC₂ from between 200° C. and 1300° C.,” J Eur Ceram Soc, vol. 25, no. 14, pp. 3367-3374, 2005.
[14] T. Yang, C. Wang, C. Taylor, X. Huang, Q. Huang, F. Li, L. Shen, X. Zhou, J. Xue, S. Yan and Y. Wang, “The structural transitions of Ti₃AlC₂ induced by ion irradiation,” Acta Mater, vol. 65, pp. 351-359, 2014.
[15] G. Song, Y. Pei, W. Sloof, S. Li, J. De Hosson and S. van der Zwaag, “Oxidation-induced crack healing in Ti₃AlC₂ ceramics,” Scr Mater, vol. 58, no. 1, pp. 13-16, 2008.
[16] B. Barua, M. C. Messner and D. Singh, “Assessment of Ti₃SiC₂ MAX phase as a structural material for high temperature receivers,” AIP Conference Proceedings, vol. 2445, no. 1, p. 030002, 2022.
[17] M. Messner, B. Barua and D. Singh, “Towards a design framework for non-metallic concentrating solar power components,” AIP Conference Proceedings, vol. 2445, no. 1, p. 020009, 2022.
[18] ASTM International, “Standard Test Method for Vickers Indentation Hardness of Advanced Ceramics C1327-15,” ASTM C1327-15, pp. 1-10, 9 Jul. 2019.
[19] ASTM International, “Standard Test Method for Flexural Strength of Advanced Ceramics at Ambient Temperature C1161-18,” ASTM C1161-18, pp. 1-19, 8 Feb. 2019.
[20] ASTM International, “Standard Test Method for Resistivity of Electrical Conductor Materials B193-20,” ASTM B193-20, pp. 1-5, 20 Nov. 2020.
[21] ASTM International, “Standard Test Method for Thermal Diffusivity by the Flash Method E1461-13,” ASTM E1461-13, pp. 1-11, 21 Apr. 2022.
[22] N. Gao, Y. Miyamoto and D. Zhang, “Dense Ti₃SiC₂ prepared by reactive HIP,” J Mater Sci, vol. 34, pp. 4385-4392, 1999.
[23] M. El Saeed, F. Deorsola and R. Rashad, “Optimization of the Ti₃SiC₂ MAX phase synthesis,” Int. Journal of Refractory Metals and Hard Material, vol. 35, pp. 127-131, 2012.
[24] N. Gao, Y. Miyamoto and D. Zhang, “On physical and thermochemical properties of high-purity Ti₃SiC₂,” Mater Lett, vol. 55, pp. 61-66, 2002.
[25] N. Gao, J. Li, D. Zhang and Y. Miyamoto, “Rapid synthesis of dense Ti₃SiC₂ by spark plasma sintering,” Journal of the European Ceramic Society, vol. 22, pp. 2365-2370, 2002.
[26] S. Amiri and N. Vafa, “Microstructure and mechanical properties of Ti₃SiC₂ MAX phases sintered by hot pressing,” Synthesis and Sintering, vol. 1, no. 4, pp. 216-222, 2021.
[27] F. Turki, H. Abderrazak, S. F., F. Tetard, M. Abdellaoui and N. Jouini, “Physico-chemical and mechanical properties of Ti₃SiC₂-based materials elaborated from SiC/Ti by reactive spark plasma sintering,” J Adv Ceram, vol. 8, no. 1, pp. 47-61, 2019.
[28] P. Chaugule et al., “Mechanical properties of MAX phase Ti₃SiC₂.” (unpublished)
[29] M. Barsoum and T. El-Raghy, “A progress report on Ti₃SiC₂, Ti₃GeC₂, and the H-phases, M₂BX,” J Mater Synth Process, vol. 5, pp. 197-216, 1997.
[30] M. Barsoum, T. El-Raghy, C. Rawn, W. Porter, H. Wang, E. Payzant and C. Hubbard, “Thermal properties of Ti₃SiC₂,” J Phys Chem Solids, vol. 60, pp. 429-439, 1999.
[31] Sun et al., Synthesis of MAX Phases by Pulse Discharge Sintering, Int. J. Appl. Ceram. Technol. 7 [6] pp. 704-718 (2010)

1. A method of making a MAX phase structure comprising one or more apertures:
forming precursor powder into a green body structure having one or more apertures;
filling the one or more apertures with an insert powder such that the insert powder completely fills the one or more apertures;
sintering the insert powder filled green body while applying a pressure load from a pressure applying insert applied to the insert powder filled green body thereby form the MAX phase structure;
wherein:
the MAX phase structure comprises a MAX phase compound of formula Mₙ₊₁AXₙ, wherein n is 1-4, wherein M is an early transition metal element, A is an A-group metal, and X is carbon or nitrogen,
the precursor powder comprises a powder of M, a powder of A, and one or both of a powder of a carbide of M and a powder of a nitride of M, and
the insert powder comprises a material that does not sinter at a temperature at which the green body is sintered.

2. The method of claim 1, wherein sintering is performed at a temperature of about 1300° C. to about 1500° C.

3. The method of claim 1, wherein the load is about 5 MPa to about 40 MPa.

4. The method of claim 1, wherein the sintering is performed under vacuum.

5. The method of claim 1, wherein filling the one or more apertures further comprises applying a layer of insert powder on a surface of the green body, such that a layer of insert powder is disposed between the surface of the green body and the pressure applying insert.

6. The method of claim 1, further comprising sintering the MAX phase structure at a temperature of about 1300° C. to about 1500° C.

7. The method of claim 1, wherein the insert powder comprises one or more of graphite, silica, boron nitride, and sand.

8. The method of claim 1, wherein M is one or more of tantalum (Ta), hafnium (Hf), titanium (Ti), vanadium (V), chromium (Cr), niobium (Nb), molybdenum (Mo), and zirconium (Zr).

9. (canceled)

10. The method of claim 1, wherein A is one or more of aluminum (Al), tin (Sn), silicon (Si), phosphorous (P), sulfur(S), gallium (Ga), germanium (Ge), arsenic (As), cadmium (Cd), indium (In), thallium (Tl), and lead (Pb).

11. (canceled)

12. (canceled)

13. The method of claim 1, wherein M is titanium (Ti), A is silicon, X is C, and the Max Phase compound having formula Mₙ₊₁AXₙ is Ti₃SiC₂.

14. The method of claim 13, wherein the precursor powder comprises Ti powder, Si powder, and TiC powder.

15. The method of claim 14, wherein the precursor powder comprises a ratio of Ti:Si:TiC of 1:1:2.

16. The method of claim 1, wherein the carbide and/or nitride of M is present in an amount of about 1 wt % to about 70 wt % by weight of the precursor powder.

17. The method of claim 1, wherein the powder of M is present in an amount of about 20 wt % to about 75 wt % by weight of the precursor powder.

18. The method of claim 1, wherein the powder of A is present in an amount of about 10 wt % to about 20 wt % by weight of the precursor powder.

19. The method of claim 1, wherein the green body is a green body tube having a central aperture.

20. The method of claim 1, wherein sintering comprising field assisted sintering performed with a voltage of about 5 V to 30 V and a current up to 150 kA.

21. The method of claim 1, wherein the sintering comprises hot isostatic pressure (HIP).

22. The method of claim 1, further comprising preparing the precursor powder by admixing the powder of M, the powder of A, and the one or both of the powder of the carbide of M and the powder of the nitride of M with an organic solvent to form a slurry and drying the slurry to form the precursor powder.

23. (canceled)

24. (canceled)

25. The method of claim 1, wherein forming the green body structure having the one or more apertures comprises compressing the precursor powder into a die having a desired shape with one or more die inserts for forming one or more apertures in the green body to thereby define a green body structure having one or more apertures; and the method further comprises removing the one or more die inserts before filling the one or more apertures with the insert powder.

26. (canceled)
